(19) United States
(12) Patent Application Publication
(10) Pub. No.: US 2019/0082457 A1
(43) Pub. Date: Mar. 14, 2019

(54) DOWNLINK CONTROL INFORMATION COMMUNICATION METHOD, TERMINAL, AND BASE STATION

(71) Applicant: HUAWEI TECHNOLOGIES CO., LTD., Shenzhen (CN)

(72) Inventors: Han ZHOU, Shanghai (CN); Shurong Jiao, Shanghai (CN); Meng Hua, Shanghai (CN)

(21) Appl. No.: 16/185,484

(22) Filed: Nov. 9, 2018

Related U.S. Application Data
(63) Continuation of application No. PCT/CN2016/081920, filed on May 12, 2016.

(51) Int. Cl. H04W 72/12; H04W 72/04; H04W 52/02

(52) U.S. Cl. CPC H04W 72/1289; H04W 52/0209; H04W 72/044

(57) ABSTRACT

Embodiments of the present invention provide a downlink control information communication method, a terminal, and a base station. The downlink control information communication method includes: receiving first-type downlink control information (DCI) sent by a base station, where the first-type DCI carries DCI indication information, and the DCI indication information is used to indicate a sending status of second-type DCI; determining, based on the DCI indication information in the currently received first-type DCI, whether the currently received first-type DCI is valid; and when the first-type DCI is valid, performing data scheduling based on most recently received second-type DCI and the currently received first-type DCI.

### CROSS-REFERENCE TO RELATED APPLICATIONS

This application is a continuation of International Application No. PCT/CN2016/081920, filed on May 12, 2016, the disclosure of which is hereby incorporated by reference in its entirety.

### TECHNICAL FIELD

The present application relates to the field of communications technology, and in particular, to a downlink control information communication method, a terminal, and a base station.

### BACKGROUND

In a Long Term Evolution (LTE) communications system, based on scheduling by an evolved NodeB (eNB), user equipment (UE) sends uplink data to the eNB and receives downlink data from the eNB. To be specific, before sending data or receiving data, the UE first receives downlink control information (DCI) sent by the eNB. The DCI indicates control signaling such as a time, a frequency resource, and a modulation and coding scheme for data sending or data receiving by the UE. After correctly receiving the DCI, the UE performs corresponding data sending or data receiving according to an indication of the control signaling in the DCI, to complete one time of data scheduling. A time unit of scheduling is referred to as a transmission time interval (TTI).

In a conventional LTE communications system, one TTI is usually one subframe, and includes 14 orthogonal frequency division multiplexing (OFDM) symbols. However, in the LTE communications system and a subsequent evolved communications system, to reduce a service latency, when one TTI includes one to seven OFDM symbols, a TTI is referred to as a short transmission time interval (short TTI, sTTI), and an LTE communications system using the sTTI may be referred to as an sTTI system. Compared with the conventional LTE communications system, the sTTI system has higher DCI signaling overheads.

To reduce the DCI signaling overheads of the sTTI system, at present, DCI is usually classified into two levels: slow DCI (also referred to as level 0 DCI) and fast DCI (also referred to as level 1 DCI). The slow DCI carries slow-change control signaling, is sent less frequently, and can span a plurality of sTTIs. The fast DCI carries rapid-change control signaling, and is sent more frequently as the fast DCI is sent during each data scheduling. The UE can obtain complete and correct DCI only by combining the slow DCI with the fast DCI, to complete data scheduling.

However, because the slow DCI is sent less frequently, if missing receiving the slow DCI, the UE uses previously received slow DCI and recently received fast DCI as complete DCI. But the complete DCI is incorrect DCI. Consequently, data scheduling performed by the UE based on the incorrect DCI fails and power consumption of the UE is wasted.

### SUMMARY

Embodiments of the present invention provide a downlink control information communication method, a terminal, and a base station, to avoid an unnecessary scheduling failure when the terminal misses receiving slow DCI, and reduce power consumption of the terminal.

In at least some embodiments, a downlink control information communication method is provided. The method includes: receiving first-type downlink control information (DCI) sent by a base station, where the first-type DCI carries DCI indication information; determining, based on the DCI indication information in the currently received first-type DCI, whether the currently received first-type DCI is valid; and when it is determined that the currently received first-type DCI is valid, performing data scheduling based on most recently received second-type DCI and the currently received first-type DCI.

In the downlink control information communication method provided in at least one embodiment, the first-type DCI sent by the base station carries the DCI indication information. The base station notifies, to a terminal based on the DCI indication information, information indicating whether new second-type DCI has been sent. The terminal receives the first-type DCI sent by the base station, and the terminal can learn, based on the DCI indication information, whether the base station has sent the new second-type DCI, and determine, based on the DCI indication information in the currently received first-type DCI, whether the currently received first-type DCI is valid. The terminal performs, based on the most recently received second-type DCI and the currently received first-type DCI, correct data scheduling only when the currently received first-type DCI is valid. This avoids a problem that the terminal performs incorrect data scheduling when the terminal misses receiving slow DCI, reduces power consumption of the terminal, and increases a scheduling success rate of the terminal.

In at least some embodiments, the method further includes: when it is determined that the currently received first-type DCI is invalid, skipping performing data scheduling indicated by the currently received first-type DCI.

In at least some embodiments, the DCI indication information is a sending version of second-type DCI; and the determining, based on the DCI indication information in the currently received first-type DCI, whether the currently received first-type DCI is valid includes: determining, based on the DCI indication information in the currently received first-type DCI and a second-type DCI baseline version maintained by a terminal, whether the currently received first-type DCI is valid.

In the downlink control information communication method provided in this possible implementation, the DCI indication information is specifically the sending version of second-type DCI, and the terminal determines, based on a second-type DCI receiving status maintained by the terminal and the sending version that is of second-type DCI and that is carried in the currently received first-type DCI, whether the currently received first-type DCI is valid. This avoids a problem that the terminal performs incorrect data scheduling when the terminal misses receiving slow DCI, reduces power consumption of the terminal, and increases a scheduling success rate of the terminal.

In at least some embodiments, the second-type DCI baseline version is DCI indication information carried in first-type DCI previously received by the terminal; and the determining, based on the DCI indication information in the currently received first-type DCI and a second-type DCI baseline version maintained by a terminal, whether the currently received first-type DCI is valid includes: determining whether the DCI indication information in the currently received first-type DCI is the same as the second-type DCI baseline version; and if the DCI indication information in the currently received first-type DCI is the same as the second-type DCI baseline version, determining that the currently received first-type DCI is valid; or if the DCI indication information in the currently received first-type DCI is different from the second-type DCI baseline version, further determining whether second-type DCI has been received after the previous first-type DCI receiving and before the current first-type DCI receiving; and if second-type DCI has been received, determining that the currently received first-type DCI is valid, or if second-type DCI has not been received, determining that the currently received first-type DCI is invalid.

In at least some embodiments, the second-type DCI baseline version is determined by the terminal based on the most recently received second-type DCI; and that the second-type DCI baseline version is determined by the terminal based on the most recently received second-type DCI includes: the second-type DCI baseline version is a sending version carried in the second-type DCI that is most recently received by the terminal; or the second-type DCI baseline version is a version updated based on the second-type DCI baseline version after the terminal has most recently received the second-type DCI.

In at least some embodiments, the determining, based on the DCI indication information in the currently received first-type DCI and a second-type DCI baseline version maintained by a terminal, whether the currently received first-type DCI is valid includes: determining whether the DCI indication information in the currently received first-type DCI is the same as the second-type DCI baseline version; and if the DCI indication information in the currently received first-type DCI is the same as the second-type DCI baseline version, determining that the currently received first-type DCI is valid; or if the DCI indication information in the currently received first-type DCI is different from the second-type DCI baseline version, determining that the currently received first-type DCI is invalid.

In at least some embodiments, the DCI indication information is a first preset value or a second preset value; the first preset value indicates that the base station has not sent second-type DCI after previous first-type DCI sending and before current first-type DCI sending; and the second preset value indicates that the base station has sent second-type DCI after the previous first-type DCI sending and before the current first-type DCI sending.

In the downlink control information communication method provided in this possible implementation, the DCI indication information is the first preset value or the second preset value. The terminal determines, based on the first preset value or the second preset value, whether the currently received first-type DCI is valid. This avoids a problem that the terminal performs incorrect data scheduling when the terminal misses receiving slow DCI, reduces power consumption of the terminal, and increases a scheduling success rate of the terminal.

In at least some embodiments, the determining, based on the DCI indication information in the currently received first-type DCI, whether the currently received first-type DCI is valid includes: if the DCI indication information is the first preset value, determining that the currently received first-type DCI is valid; or if the DCI indication information is the second preset value, further determining whether second-type DCI has been received after previous first-type DCI receiving and before the current first-type DCI receiving; and if second-type DCI has been received, determining that the currently received first-type DCI is valid, or if second-type DCI has not been received, determining that the currently received first-type DCI is invalid.

In at least some embodiments, second-type DCI is sent by the base station based on a preset period, and the DCI indication information is a third preset value or a fourth preset value; the third preset value indicates that the base station has not sent second-type DCI within a current second-type DCI sending period; and the fourth preset value indicates that the base station has sent second-type DCI within the current second-type DCI sending period.

The downlink control information communication method provided in this possible implementation is applied to a scenario in which second-type DCI is periodically sent. The DCI indication information is the third preset value or the fourth preset value. The terminal determines, based on the third preset value or the fourth preset value, whether the currently received first-type DCI is valid. This avoids a problem that the terminal performs incorrect data scheduling when the terminal misses receiving slow DCI, reduces power consumption of the terminal, and increases a scheduling success rate of the terminal.

In at least some embodiments, the determining, based on the DCI indication information in the currently received first-type DCI, whether the currently received first-type DCI is valid includes: if the DCI indication information is the third preset value, determining that the currently received first-type DCI is valid; or if the DCI indication information is the fourth preset value, further determining whether second-type DCI has been received within the current second-type DCI sending period; and if second-type DCI has been received, determining that the currently received first-type DCI is valid, or if second-type DCI has not been received, determining that the currently received first-type DCI is invalid.

In at least some embodiments, the method further includes: sending first DCI feedback information to the base station, where the first DCI feedback information is used to indicate whether the currently received first-type DCI is valid.

In the downlink control information communication method provided in this possible implementation, the terminal notifies, to the base station based on the first DCI feedback information, a result of determining whether the first-type DCI is valid, and the base station performs corresponding processing based on the first DCI feedback information. This avoids a waste of time-frequency resources on the base station side caused when the terminal misses receiving second-type DCI.

In at least some embodiments, the sending, by the terminal, first DCI feedback information to the base station includes: if the first-type DCI currently received by the terminal is invalid, sending the first DCI feedback information including a negative acknowledgment indication to the base station; or if the first-type DCI currently received by the terminal is valid, skipping sending the first DCI feedback information.

In at least some embodiments, the method further includes: sending second DCI feedback information to the base station, where the second DCI feedback information is used to indicate whether the terminal has received second-type DCI.

In the downlink control information communication method provided in this possible implementation, the terminal notifies, to the base station based on the second DCI feedback information, a result of determining whether the terminal has received second-type DCI, and the base station performs corresponding processing based on the second DCI feedback information. This avoids a waste of time-frequency resources on the base station side caused when the terminal misses receiving second-type DCI.

In at least some embodiments, the sending, by the terminal, second DCI feedback information to the base station includes: if the terminal has not received second-type DCI, sending the second DCI feedback information including a negative acknowledgment indication to the base station; or if the terminal has received second-type DCI, skipping sending the second DCI feedback information.

In at least some embodiments a downlink control information communication method is provided. The method includes: generating downlink control information (DCI) indication information; and sending first-type DCI to a terminal, where the first-type DCI carries the DCI indication information.

In at least some embodiments, the DCI indication information is a sending version of second-type DCI; and the generating DCI indication information includes: determining whether second-type DCI has been sent to the terminal after previous first-type DCI sending and before the current first-type DCI sending; and if second-type DCI has been sent, using the sending version of the second-type DCI as the DCI indication information in the current first-type DCI.

In at least some embodiments, the generating DCI indication information includes: determining whether second-type DCI has been sent to the terminal after previous first-type DCI sending and before the current first-type DCI sending; and if second-type DCI has not been sent, setting the DCI indication information in the current first-type DCI to a first preset value; or if second-type DCI has been sent, setting the DCI indication information in the current first-type DCI to a second preset value.

In at least some embodiments, a base station sends second-type DCI based on a preset period, and the generating DCI indication information includes: determining whether second-type DCI has been sent to the terminal within a current second-type DCI sending period; and if second-type DCI has not been sent, setting the DCI indication information in the first-type DCI that is within the current second-type DCI sending period to a third preset value; or if second-type DCI has been sent, setting the DCI indication information in the first-type DCI that is within the current second-type DCI sending period to a fourth preset value.

In at least some embodiments, the method further includes: receiving first DCI feedback information sent by the terminal, where the first DCI feedback information is used to indicate whether the first-type DCI currently received by the terminal is valid; and determining, based on the first DCI feedback information, whether to resend second-type DCI corresponding to the first DCI feedback information.

In at least some embodiments, the method further includes: receiving second DCI feedback information sent by the terminal, where the second DCI feedback information is used to indicate whether the terminal has received second-type DCI; and determining, based on the second DCI feedback information, whether to resend second-type DCI corresponding to the second DCI feedback information.

In at least some embodiments, the method further includes: receiving downlink scheduling feedback information sent by the terminal; and sending second-type DCI if the downlink scheduling feedback information indicates that the terminal has not received downlink scheduling data sent by the base station; or sending second-type DCI if uplink scheduling data sent by the terminal has not been received on a preset time-frequency resource.

In at least some embodiments, a terminal is provided. The terminal includes a processor, and a transceiver coupled to the processor. The transceiver is configured to receive first-type downlink control information (DCI) sent by a base station, where the first-type DCI carries DCI indication information. The processor is configured to determine, based on the DCI indication information in the currently received first-type DCI, whether the currently received first-type DCI is valid. When determining that the currently received first-type DCI is valid, the processor performs data scheduling based on most recently received second-type DCI and the currently received first-type DCI.

In at least some embodiments, the processor is further configured to: when determining that the currently received first-type DCI is invalid, skip performing data scheduling indicated by the currently received first-type DCI.

In at least some embodiments, the DCI indication information is a sending version of second-type DCI; and the processor is configured to: determine, based on the DCI indication information in the currently received first-type DCI and a second-type DCI baseline version maintained by the processor, whether the currently received first-type DCI is valid.

In at least some embodiments, the second-type DCI baseline version is DCI indication information carried in first-type DCI previously received by the transceiver; and the processor is configured to: determine whether the DCI indication information in the currently received first-type DCI is the same as the second-type DCI baseline version; and if the DCI indication information in the currently received first-type DCI is the same as the second-type DCI baseline version, determine that the currently received first-type DCI is valid; or if the DCI indication information in the currently received first-type DCI is different from the second-type DCI baseline version, further determine whether second-type DCI has been received after the previous first-type DCI receiving and before the current first-type DCI receiving; and if second-type DCI has been received, determine that the currently received first-type DCI is valid, or if second-type DCI has not been received, determine that the currently received first-type DCI is invalid.

In at least some embodiments, the second-type DCI baseline version is determined by the processor based on the most recently received second-type DCI; and that the second-type DCI baseline version is determined by the processor based on the most recently received second-type DCI includes: the second-type DCI baseline version is a sending version carried in the second-type DCI that is most recently received by the transceiver; or the second-type DCI baseline version is a version updated based on the second-type DCI baseline version after the processor has most recently received the second-type DCI.

In at least some embodiments, the processor is configured to: determine whether the DCI indication information in the currently received first-type DCI is the same as the second-type DCI baseline version; and if the DCI indication information in the currently received first-type DCI is the same as the second-type DCI baseline version, determine that the currently received first-type DCI is valid; or if the DCI indication information in the currently received first-type DCI is different from the second-type DCI baseline version, determine that the currently received first-type DCI is invalid.

In at least some embodiments, the DCI indication information is a first preset value or a second preset value; the first preset value indicates that the base station has not sent second-type DCI after previous first-type DCI sending and before current first-type DCI sending; and the second preset value indicates that the base station has sent second-type DCI after the previous first-type DCI sending and before the current first-type DCI sending.

In at least some embodiments, the processor is configured to: if the DCI indication information is the first preset value, determine that the currently received first-type DCI is valid; or if the DCI indication information is the second preset value, further determine whether second-type DCI has been received after previous first-type DCI receiving and before the current first-type DCI receiving; and if second-type DCI has been received, determine that the currently received first-type DCI is valid, or if second-type DCI has not been received, determine that the currently received first-type DCI is invalid.

In at least some embodiments, second-type DCI is sent by the base station based on a preset period, and the DCI indication information is a third preset value or a fourth preset value; the third preset value indicates that the base station has not sent second-type DCI within a current second-type DCI sending period; and the fourth preset value indicates that the base station has sent second-type DCI within the current second-type DCI sending period.

In at least some embodiments, the processor is configured to: if the DCI indication information is the third preset value, determine that the currently received first-type DCI is valid; or if the DCI indication information is the fourth preset value, further determine whether second-type DCI has been received within the current second-type DCI sending period; and if second-type DCI has been received, determine that the currently received first-type DCI is valid, or if second-type DCI has not been received, determine that the currently received first-type DCI is invalid.

In at least some embodiments, the transceiver is further configured to: send first DCI feedback information to the base station, where the first DCI feedback information is used to indicate whether the currently received first-type DCI is valid.

In at least some embodiments, the transceiver is configured to: if the currently received first-type DCI is invalid, send the first DCI feedback information including a negative acknowledgment indication to the base station; or if the currently received first-type DCI is valid, skip sending the first DCI feedback information.

In at least some embodiments, the transceiver is further configured to: send second DCI feedback information to the base station, where the second DCI feedback information is used to indicate whether the transceiver has received second-type DCI.

In at least some embodiments, the transceiver is configured to: if the transceiver has not received second-type DCI, send the second DCI feedback information including a negative acknowledgment indication to the base station; or if the transceiver has received second-type DCI, skip sending the second DCI feedback information.

In at least some embodiments, a base station is provided. The base station includes a processor, and a transceiver coupled to the processor. The processor is configured to generate downlink control information (DCI) indication information. The transceiver is configured to send first-type DCI to a terminal, where the first-type DCI carries the DCI indication information.

In at least some embodiments, the DCI indication information is a sending version of second-type DCI; and the processor is configured to: determine whether second-type DCI has been sent to the terminal after previous first-type DCI sending and before the current first-type DCI sending; and if second-type DCI has been sent, use the sending version of the second-type DCI as the DCI indication information in the current first-type DCI.

In at least some embodiments, the processor is configured to: determine whether second-type DCI has been sent to the terminal after previous first-type DCI sending and before the current first-type DCI sending; and if second-type DCI has not been sent, set the DCI indication information in the current first-type DCI to a first preset value; or if second-type DCI has been sent, set the DCI indication information in the current first-type DCI to a second preset value.

In at least some embodiments, the transceiver sends second-type DCI based on a preset period, and the processor is configured to: determine whether second-type DCI has been sent to the terminal within a current second-type DCI sending period; and if second-type DCI has not been sent, set the DCI indication information in the first-type DCI that is within the current second-type DCI sending period to a third preset value; or if second-type DCI has been sent, set the DCI indication information in the first-type DCI that is within the current second-type DCI sending period to a fourth preset value.

In at least some embodiments, the transceiver is further configured to: receive first DCI feedback information sent by the terminal, where the first DCI feedback information is used to indicate whether the first-type DCI currently received by the terminal is valid; and determine, based on the first DCI feedback information, whether to resend second-type DCI corresponding to the first DCI feedback information.

In at least some embodiments, the transceiver is further configured to: receive second DCI feedback information sent by the terminal, where the second DCI feedback information is used to indicate whether the terminal has received second-type DCI; and determine, based on the second DCI feedback information, whether to resend second-type DCI corresponding to the second DCI feedback information.

In at least some embodiments, the transceiver is further configured to: receive downlink scheduling feedback information sent by the terminal; and send second-type DCI if the downlink scheduling feedback information indicates that the terminal has not received downlink scheduling data sent by the base station; or send second-type DCI if uplink scheduling data sent by the terminal has not been received on a preset time-frequency resource.

With reference to the first aspect and the possible implementations of the first aspect, the second aspect and the possible implementations of the second aspect, the third aspect and the possible implementations of the third aspect, the fourth aspect and the possible implementations of the fourth aspect, the DCI indication information is used to indicate a sending status of second-type DCI.

The embodiments of the present invention provide the downlink control information communication method, the terminal, and the base station, and the downlink control information communication method includes: generating, by the base station, the DCI indication information, where the DCI indication information is used to indicate the sending status of second-type DCI; sending, by the base station, the first-type DCI to the terminal, where the first-type DCI carries the DCI indication information; receiving, by the terminal, the first-type DCI sent by the base station; determining, by the terminal based on the DCI indication information in the currently received first-type DCI, whether the currently received first-type DCI is valid; and when determining that the currently received first-type DCI is valid, performing, by the terminal, data scheduling based on the most recently received second-type DCI and the currently received first-type DCI. In the downlink control information communication method provided in the embodiments of the present invention, the terminal performs correct data scheduling only when determining that the first-type DCI is valid. This avoids a problem that the terminal performs incorrect data scheduling when the terminal misses receiving second-type DCI, increases a scheduling success rate of the terminal, and reduces power consumption of the terminal.

### BRIEF DESCRIPTION OF DRAWINGS

To describe the technical solutions in the embodiments of the present invention more clearly, the following briefly describes the accompanying drawings according to at least some embodiments. Apparently, the accompanying drawings in the following description show some embodiments of the present invention, and persons of ordinary skill in the art may still derive other drawings from these accompanying drawings.

FIG. 1 is an architectural diagram of a system of a downlink control information communication method according to an embodiment of the present invention;

FIG. 2 is a signaling flowchart of a downlink control information communication method according to the embodiments of the present invention;

FIG. 3A is a schematic structural diagram of a downlink resource in a downlink control information communication method according to the embodiments of the present invention;

FIG. 3B is another schematic structural diagram of a downlink resource in a downlink control information communication method according to the embodiments of the present invention;

FIG. 4 is a schematic structural diagram of a downlink resource in a downlink control information communication method according to the embodiments of the present invention;

FIG. 5 is a schematic structural diagram of a downlink resource in a downlink control information communication method according to the embodiments of the present invention;

FIG. 6 is a signaling flowchart of a downlink control information communication method according to the embodiments of the present invention;

FIG. 7 is a signaling flowchart of a downlink control information communication method according to the embodiments of the present invention;

FIG. 8 is a schematic structural diagram of a terminal according to the embodiments of the present invention; and

FIG. 9 is a schematic structural diagram of a base station according to the embodiments of the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention shall fall within the protection scope of the present application.

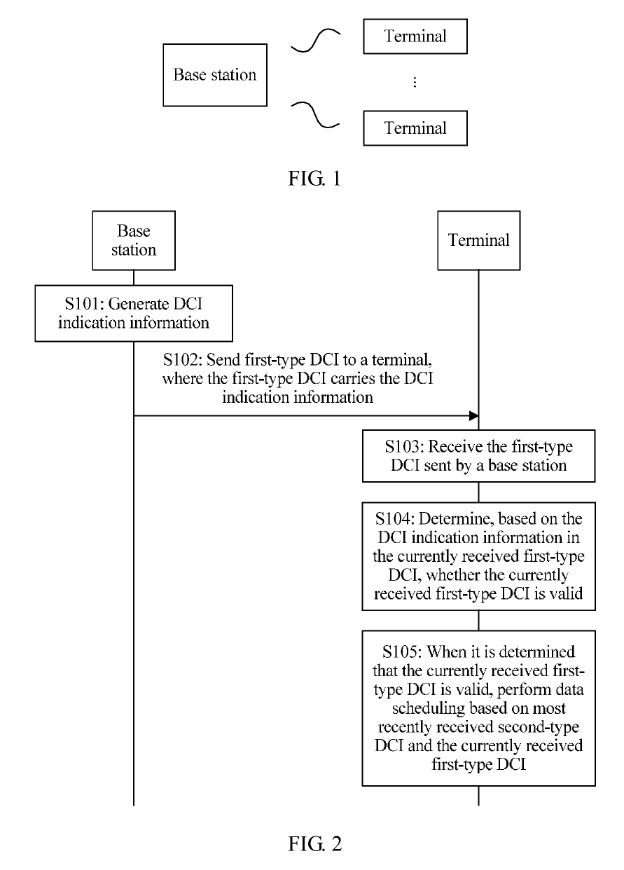

A downlink control information communication method provided in the embodiments of the present invention can be applied to data scheduling in an LTE communications system, a subsequent evolved communications system, and a 5G communications system using a short transmission time interval sTTI. The communications system using the short transmission time interval sTTI is also referred to as an sTTI system. In the sTTI system, a downlink data channel is referred to as a short physical downlink shared channel (sPDSCH), an uplink data channel is referred to as a short physical uplink shared channel (sPUSCH), and an uplink control channel is referred to as a short physical uplink control channel (sPUCCH). One short transmission time interval sTTI includes one to seven OFDM symbols. When the short transmission time interval sTTI includes only one OFDM symbol, the short transmission time interval sTTI is also referred to as a symbol transmission time interval (symbol TTI, sTTI). In the sTTI system, DCI is classified into two levels of DCI, and the two levels of DCI include different control information. FIG. 1 is an architectural diagram of a system of a downlink control information communication method according to an embodiment of the present invention. As shown in FIG. 1, the system includes a base station and a terminal. The base station has a signal coverage area. When the terminal is within the coverage area of the base station, the terminal may perform data communication with the base station, and the base station implements uplink and downlink data scheduling by using two levels of DCI.

The terminal in the embodiments of the present invention may be a wireless terminal such as a mobile phone or a tablet computer. The wireless terminal includes a device providing voice and/or data services for a user, or the terminal may be a device with a wireless connection function such as a handheld device, an in-vehicle device, a wearable device, or a computing device, or a device in various forms such as user equipment UE, a mobile station (MS), or a terminal. This is not limited in the embodiments of the present invention.

The base station in the embodiments of the present invention may be any device with a function of managing a radio network resource in an LTE communications system and a subsequent evolved communications system. For example, the base station may be an evolved NodeB eNB in LTE, or may be a radio transceiver device (NeXt Node, NX) in 5G. This is not limited in the embodiments of the present invention.

The downlink control information communication method in the embodiments of the present invention is to resolve technical problems that when UE misses receiving slow DCI sent by an eNB, data scheduling by the UE fails and power consumption of the UE is wasted in the sTTI system.

The following uses specific embodiments to describe in detail the technical solutions of the present application and how the foregoing technical problems are resolved by using the technical solutions of the present application. The following specific embodiments may be mutually combined, and same or similar concepts or processes may not be repeatedly described in some embodiments.

FIG. 2 is a signaling flowchart of a downlink control information communication method according to the embodiments of the present invention. As shown in FIG. 2, the downlink control information communication method provided in the embodiment of the present invention may include the following operations.

S101: A base station generates DCI indication information. The DCI indication information is used to indicate a sending status of second-type DCI.

In the embodiment of the present invention, DCI includes first-type DCI and second-type DCI. The first-type DCI carries fast-change control information, and the second-type DCI carries slow-change control information. The first-type DCI may be fast DCI or level 1 DCI. The second-type DCI may be slow DCI or level 0 DCI. Both the first-type DCI and the second-type DCI include scheduling information, and the scheduling information is used to instruct a terminal to receive downlink data or instruct a terminal to send uplink data. The first-type DCI and the second-type DCI include different scheduling information. The first-type DCI and the second-type DCI are combined to determine complete and correct DCI. Therefore, it can be understood that there is a dependency relationship between the first-type DCI and second-type DCI. In addition to the scheduling information, the first-type DCI and the second-type DCI include other control information.

It should be noted that, specific control information included in the first-type DCI and in the second-type DCI is not limited in the embodiment of the present invention. For example, the first-type DCI may include: (1) a hybrid automatic repeat request (HARQ) process identifier; (2) scheduling resource allocation, including time domain resource allocation and frequency domain resource allocation; (3) a short physical downlink shared channel (sPDSCH) rate matching indication, used to reduce a resource allocation fragment that may be caused when an sTTI system and a conventional LTE system multiplex a same frequency resource; (4) precoding information and antenna port information; (5) a new data indication, used for a HARQ and a retransmission indication; (6) uplink reference signal related information, used to indicate a frame structure of a physical uplink control channel (PUCCH), and the like. The second-type DCI may include: (1) an uplink/downlink scheduling identifier, used to indicate a DCI format; (2) a modulation and coding scheme (MCS) baseline, used to indicate a subtable of an entire modulation and coding scheme table; (3) a transmission power control command; (4) scheduling information of the first-type DCI, used to reduce a quantity of blind detections performed by the terminal on the first-type DCI, and the like.

The sending status of the second-type DCI is used to indicate whether the second-type DCI on which the first-type DCI depends has changed, or whether the second-type DCI on which the first-type DCI depends has been sent. The sending status of the second-type DCI includes new second-type DCI or original second-type DCI.

Optionally, the DCI indication information may be an N-digit binary bit, where N is an integer greater than 0. For example, if N=3, the DCI indication information has 8 values in total, and corresponding decimal values are 0 to 7; if N=1, the DCI indication information has 2 values in total, and corresponding decimal values are 0 and 1.

In the embodiment of the present invention, the DCI indication information may have a plurality of implementations, and this is not limited in the embodiment of the present invention.

In one implementation, the DCI indication information may be a sending version of the second-type DCI. The sending version of the second-type DCI is used to uniquely differentiate whether control information carried in two consecutive pieces of second-type DCI is the same. For example, in a scenario in which second-type DCI is aperiodically sent, if two consecutive pieces of second-type DCI carry different control information, sending versions of the two consecutive pieces of second-type DCI are different. In a scenario in which second-type DCI is periodically sent, if two consecutive pieces of second-type DCI may carry same control information, sending versions of the two consecutive pieces of second-type DCI are the same. Therefore, the sending status of the second-type DCI may be indicated by using two consecutive pieces of DCI indication information. To be specific, when the two consecutive pieces of DCI indication information are the same, it may indicate that the second-type DCI is not new second-type DCI, and the sending status of the second-type DCI is original second-type DCI. When the two consecutive pieces of DCI indication information are different, it may indicate that the second-type DCI has changed, and the sending status of the second-type DCI is new second-type DCI.

Optionally, loop counting may be performed on the sending version of the second-type DCI, and the loop counting may include ascending loop counting and descending loop counting. For example, the sending version of the second-type DCI is an M-digit binary bit, where M is an integer greater than 0. For two consecutive pieces of second-type DCI, a sending version of previous second-type DCI is represented as kᵢ₋₁, and a sending version of current second-type DCI is represented as kᵢ. If the two consecutive pieces of second-type DCI carry different control information, kᵢ=(kᵢ₋₁+1)mod 2^{M}. For example, M=3, and two consecutive pieces of second-type DCI carry different control information. If a sending version of previous second-type DCI is a decimal value of 6, a sending version of current second-type DCI is a decimal value of 7; if a sending version of previous second-type DCI is a decimal value of 7, a sending version of current second-type DCI is a decimal value of 0.

Optionally, alternate counting of two values may be performed on the sending version of the second-type DCI. For example, if four consecutive pieces of second-type DCI carry different control information, a sending version of a first piece of second-type DCI is A, a sending version of a second piece of second-type DCI is B, a sending version of a third piece of second-type DCI is A, and a sending version of a fourth piece of second-type DCI is B.

In another implementation, the DCI indication information may be an absolute value used to identify whether the second-type DCI has changed. In other words, an absolute value with a definite meaning is used to identify whether the second-type DCI is new second-type DCI. For example, a value C identifies that the second-type DCI remains unchanged and is original second-type DCI, and a value D identifies that the second-type DCI has changed and is new second-type DCI. Therefore, the DCI indication information may indicate the sending status of the second-type DCI. To be specific, when the DCI indication information is the value C, it may indicate that the second-type DCI remains unchanged, and the sending status of the second-type DCI is original second-type DCI; when the DCI indication information is the value D, it may indicate that the second-type DCI has changed, and the sending status of the second-type DCI is new second-type DCI.

Optionally, a transmission mode of the DCI indication information may include an explicit mode or a cyclic redundancy check (CRC) implicit mode. The CRC implicit mode means that modulo-2 addition operation processing is performed on the DCI indication information and CRC check information of the first-type DCI. The explicit mode, corresponding to the CRC implicit mode, means that no operation processing is performed on the DCI indication information and the CRC check information of the first-type DCI, and that the DCI indication information and the CRC check information of the first-type DCI are directly added to a DCI information field.

S102: The base station sends first-type DCI to a terminal, where the first-type DCI carries the DCI indication information.

Specifically, the base station sends the first-type DCI to the terminal during each data transmission. Data transmission means that the base station sends downlink data to the terminal or schedules the terminal to send uplink data.

In the embodiment of the present invention, the first-type DCI carries the DCI indication information, and the DCI indication information indicates the sending status of the second-type DCI. To be specific, the base station notifies, to the terminal based on the DCI indication information, information indicating whether the second-type DCI on which the first-type DCI depends has changed and whether the second-type DCI is new second-type DCI, namely, the base station notifies, to the terminal, information indicating whether new second-type DCI has been sent.

S103: The terminal receives the first-type DCI sent by the base station.

The first-type DCI carries the DCI indication information, and the DCI indication information is used to indicate the sending status of the second-type DCI.

In the embodiment of the present invention, the terminal receives the first-type DCI. The first-type DCI carries the DCI indication information, and the DCI indication information indicates the sending status of the second-type DCI. Therefore, the terminal can learn, based on the DCI indication information, whether the second-type DCI on which the received first-type DCI depends has changed, and the terminal can further learn whether the base station side has sent new second-type DCI.

S104: The terminal determines, based on the DCI indication information in the currently received first-type DCI, whether the currently received first-type DCI is valid.

In the conventional techniques, the terminal performs corresponding data scheduling on each piece of received first-type DCI. However, the terminal may miss receiving slow DCI, and not all received first-type DCI is valid, causing a problem that scheduling fails because the terminal misses receiving the slow DCI. In the embodiment of the present invention, the terminal first determines, based on the DCI indication information in the first-type DCI, whether the currently received first-type DCI is valid, and then performs further processing based on a determining result, and the terminal may identify, based on the determining, whether the first-type DCI is valid. This can avoid a problem that the terminal performs incorrect data scheduling when the first-type DCI is invalid, and increase a data scheduling success rate.

That the first-type DCI is valid is opposite to that the first-type DCI is invalid.

That the first-type DCI is valid means that complete scheduling information that is obtained by the terminal by parsing a combination of the currently received first-type DCI and most recently received second-type DCI is valid. In other words, the first-type DCI currently received by the terminal is corresponding to the second-type DCI that is most recently received by the terminal. Based on the complete scheduling information, the terminal may receive downlink data on a downlink time-frequency resource indicated by the scheduling information or send uplink data on an uplink time-frequency resource indicated by the scheduling information.

That the first-type DCI is invalid means that complete scheduling information that is obtained by the terminal by parsing a combination of the currently received first-type DCI and most recently received second-type DCI is invalid. In other words, the first-type DCI currently received by the terminal is not corresponding to the second-type DCI that is most recently received by the terminal. The terminal cannot perform correct data scheduling based on the invalid and incorrect scheduling information, namely the terminal cannot complete downlink data receiving or uplink data sending. It can be understood that, that the first-type DCI is invalid does not mean that scheduling information carried in the first-type DCI is incorrect or other control information carried in the first-type DCI is invalid, and merely means that the scheduling information carried in the first-type DCI cannot be used, and the terminal may perform related processing based on the other control information carried in the first-type DCI. For example, the first-type DCI may carry a transmission power control command, and when determining that the first-type DCI is invalid, the terminal can still use the transmission power control command for subsequent uplink transmit power computation.

S105: When determining that the currently received first-type DCI is valid, the terminal performs data scheduling based on most recently received second-type DCI and the currently received first-type DCI.

Specifically, when the terminal determines that the currently received first-type DCI is valid, it indicates that the first-type DCI currently received by the terminal is corresponding to the second-type DCI that is most recently received by the terminal. Therefore, the currently received first-type DCI and the most recently received second-type DCI may be used to determine the complete and correct DCI. The terminal may perform correct data scheduling based on the complete and correct DCI, without considering impact of signal strength, a channel status, and other factors.

It can be learned that, in the downlink control information communication method provided in the embodiment of the present invention, the first-type DCI sent by the base station carries the DCI indication information, and the DCI indication information is used to indicate the sending status of the second-type DCI. To be specific, the base station notifies, to the terminal based on the DCI indication information, information indicating whether new second-type DCI has been sent. The terminal receives the first-type DCI sent by the base station, and the terminal can learn, based on the DCI indication information, whether the base station has sent the new second-type DCI, and determine, based on the DCI indication information in the currently received first-type DCI, whether the currently received first-type DCI is valid. The terminal performs, based on the most recently received second-type DCI and the currently received first-type DCI, correct data scheduling only when the currently received first-type DCI is valid. This avoids a prior-art problem that the terminal performs incorrect data scheduling when the terminal misses receiving slow DCI, reduces power consumption of the terminal, and increases a scheduling success rate of the terminal.

Data scheduling in the embodiment of the present invention means downlink data receiving or uplink data sending performed by the terminal.

Optionally, the downlink control information communication method provided in the embodiment of the present invention may further include:

when it is determined that the currently received first-type DCI is invalid, skipping performing data scheduling indicated by the currently received first-type DCI.

Specifically, when the terminal determines that the currently received first-type DCI is invalid, it indicates that the first-type DCI currently received by the terminal is not corresponding to the second-type DCI that is most recently received by the terminal. Therefore, the currently received first-type DCI and the most recently received second-type DCI cannot be used to determine the complete and correct DCI. In this case, the terminal does not perform data scheduling indicated by the currently received first-type DCI, thereby reducing power consumption of the terminal.

Optionally, before S101, the method may further include:

the base station determines whether the terminal initially enters an sTTI mode; and

if the terminal initially enters the sTTI mode, the base station sets first-type DCI indication information to a preset initial value.

The preset initial value may be set as needed, and this is not particularly limited in this embodiment of the present invention. For example, the preset initial value may be set to 0.

Optionally, that the base station determines whether the terminal initially enters an sTTI mode may include:

if a communications system to which the base station belongs is the sTTI system, the base station determines whether the terminal switches from an idle state to a connected state; or

the base station determines whether to send a radio resource control (RRC) message to the terminal, where the RRC message is used to indicate that the terminal enters the sTTI mode at a preset moment.

The embodiment of the present invention provides the downlink control information communication method, including: generating, by the base station, the DCI indication information, where the DCI indication information is used to indicate the sending status of the second-type DCI; sending, by the base station, the first-type DCI to the terminal, where the first-type DCI carries the DCI indication information; receiving, by the terminal, the first-type DCI sent by the base station; determining, by the terminal based on the DCI indication information in the currently received first-type DCI, whether the currently received first-type DCI is valid; and when determining that the currently received first-type DCI is valid, performing, by the terminal, data scheduling based on the most recently received second-type DCI and the currently received first-type DCI. In the downlink control information communication method provided in the embodiment of the present invention, the terminal performs correct data scheduling only when the first-type DCI is valid. This avoids a problem that the terminal performs incorrect data scheduling when the terminal misses receiving the second-type DCI, increases a scheduling success rate of the terminal, and reduces power consumption of the terminal.

Based on the embodiment shown in FIG. 2, the embodiment of a downlink control information communication method provided in the embodiments of the present invention provides another implementation of the downlink control information communication method, and particularly provides specific implementations of S101 and S104 with regard to a case in which DCI indication information is a sending version of second-type DCI.

In the embodiment of the present invention, the DCI indication information is the sending version of the second-type DCI, and that a base station generates DCI indication information in S101 may include:

the base station determines whether the second-type DCI has been sent to the terminal after previous first-type DCI sending and before the current first-type DCI sending; and

if the second-type DCI has been sent, the base station uses the sending version of the second-type DCI as the DCI indication information in the current first-type DCI; or

if the second-type DCI has not been sent, the base station uses DCI indication information in previously sent first-type DCI as the DCI indication information in the current first-type DCI.

The following describes the foregoing operations in detail by using specific examples.

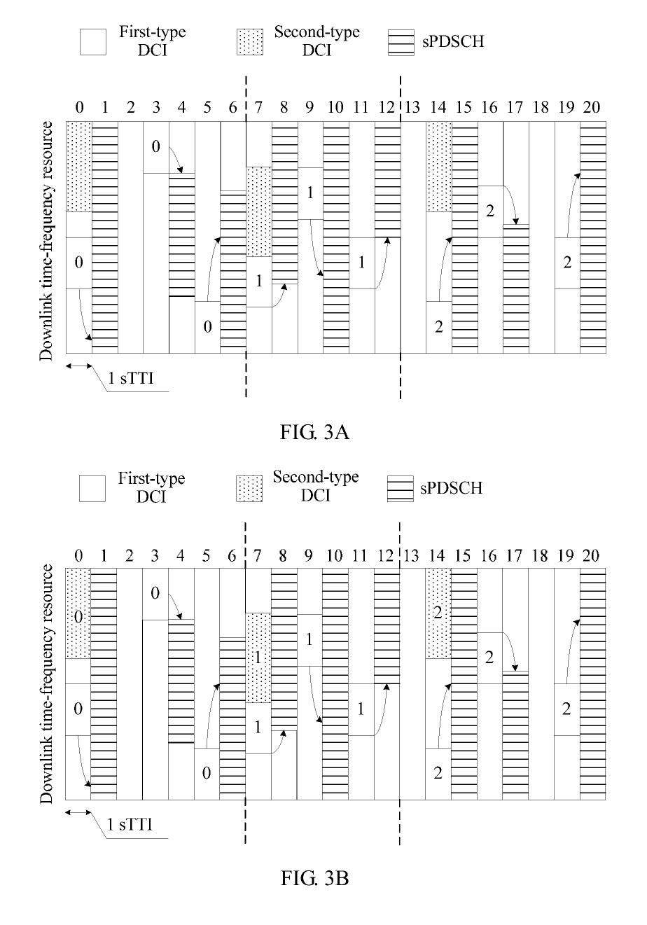

FIG. 3A is a schematic structural diagram of a downlink time-frequency resource in the downlink control information communication method according to the embodiments of the present invention. As shown in FIG. 3A, an sTTI is a symbol TTI, numbers of sTTIs are 0 to 20, and the sTTIs are marked as an sTTI0 to an sTTI020. Downlink data sent by the base station is transmitted on an sPDSCH, and ascending loop counting is performed on the sending version of the second-type DCI. Both the sending version of the second-type DCI and the DCI indication information are 3-digit binary bits, and a preset initial value of the DCI indication information is 0.

After the base station determines that the terminal enters an sTTI mode, the base station sends a first piece of first-type DCI and a first piece of second-type DCI in the sTTI0. A sending version of the first piece of second-type DCI is 0, and DCI indication information in the first piece of first-type DCI is initialized as 0.

After sending the first-type DCI in the sTTI0, the base station sends current first-type DCI in the sTTI3. The base station needs to determine whether second-type DCI has been sent to the terminal after the first-type DCI sending in the sTTI0 and before the current first-type DCI sending in the sTTI3. If it is determined that the second-type DCI has not been sent, DCI indication information in the current first-type DCI sent in the sTTI3 keeps unchanged, and is still 0.

After sending first-type DCI in the sTTI5, the base station sends current first-type DCI in the sTTI7. The base station needs to determine whether second-type DCI has been sent to the terminal after the first-type DCI sending in the sTTI5 and before the current first-type DCI sending in the sTTI7. If it is determined that the second-type DCI has been sent, and a sending version of the sent second-type DCI is 1, DCI indication information in the current first-type DCI sent in the sTTI7 changes to 1.

In the embodiment of the present invention, the DCI indication information is the sending version of the second-type DCI, and that the terminal determines, based on the DCI indication information in the currently received first-type DCI, whether the currently received first-type DCI is valid in S104 may include:

the terminal determines, based on the DCI indication information in the currently received first-type DCI and a second-type DCI baseline version maintained by the terminal, whether the currently received first-type DCI is valid.

The second-type DCI baseline version maintained by the terminal is used to indicate version information of the second-type DCI received by the terminal.

In one implementation, the second-type DCI baseline version is DCI indication information carried in first-type DCI previously received by the terminal.

That the terminal determines, based on the DCI indication information in the currently received first-type DCI and a second-type DCI baseline version maintained by the terminal, whether the currently received first-type DCI is valid may include:

the terminal determines whether the DCI indication information in the currently received first-type DCI is the same as the second-type DCI baseline version; and

if the DCI indication information in the currently received first-type DCI is the same as the second-type DCI baseline version, the terminal determines that the currently received first-type DCI is valid; or

if the DCI indication information in the currently received first-type DCI is different from the second-type DCI baseline version, the terminal further determines whether the second-type DCI has been received after the previous first-type DCI receiving and before the current first-type DCI receiving; and

if the second-type DCI has been received, the terminal determines that the currently received first-type DCI is valid, or if the second-type DCI has not been received, the terminal determines that the currently received first-type DCI is invalid.

The following describes the foregoing operations in detail by using specific examples.

As shown in FIG. 3A, the terminal receives the current first-type DCI in the sTTI3 (It should be noted that, FIG. 3A shows the structure of the downlink time-frequency resource, and the sTTI3 is a downlink sTTI number. For ease of description, the sTTI number shown in FIG. 3A is used to describe receiving on the terminal side). The second-type DCI baseline version maintained by the terminal is a DCI identifier (0) in the first-type DCI received by the terminal in the sTTI0. The terminal determines whether the DCI indication information (0) in the currently received first-type DCI is the same as the second-type DCI baseline version (0). If the DCI indication information (0) is the same as the second-type DCI baseline version (0), the terminal determines that the current first-type DCI received in the sTTI3 is valid.

The terminal receives the current first-type DCI in the sTTI7, and the second-type DCI baseline version maintained by the terminal is a DCI identifier (0) in the first-type DCI received by the terminal in the sTTI5. The terminal determines whether the DCI indication information (1) in the currently received first-type DCI is the same as the second-type DCI baseline version (0). If the DCI indication information (1) is different from the second-type DCI baseline version (0), the terminal further needs to determine whether the second-type DCI has been received after the first-type DCI receiving in the sTTI5 and before the first-type DCI receiving in the sTTI7. If having received the second-type DCI in the sTTI7, the terminal determines that the current first-type DCI received in the sTTI7 is valid, or if having not received the second-type DCI in the sTTI7, the terminal determines that the current first-type DCI received in the sTTI7 is invalid.

In another implementation, that the second-type DCI baseline version is determined by the terminal based on the most recently received second-type DCI may include:

the second-type DCI baseline version is a sending version carried in the second-type DCI that is most recently received by the terminal; or

the second-type DCI baseline version is a version updated based on the second-type DCI baseline version after the terminal has most recently received the second-type DCI.

That the terminal determines, based on the DCI indication information in the currently received first-type DCI and a second-type DCI baseline version maintained by the terminal, whether the currently received first-type DCI is valid may include:

the terminal determines whether the DCI indication information in the currently received first-type DCI is the same as the second-type DCI baseline version; and

if the DCI indication information in the currently received first-type DCI is the same as the second-type DCI baseline version, the terminal determines that the currently received first-type DCI is valid; or

if the DCI indication information in the currently received first-type DCI is different from the second-type DCI baseline version, the terminal determines that the currently received first-type DCI is invalid.

The following describes the foregoing operations in detail by using specific examples.

FIG. 3B is a schematic structural diagram of a downlink time-frequency resource in the downlink control information communication method according to the embodiments of the present invention. As shown in FIG. 3B, an sTTI is a symbol TTI, numbers of sTTIs are 0 to 20, and the sTTIs are marked as an sTTI0 to an sTTI020. Downlink data sent by the base station is transmitted on an sPDSCH, and ascending loop counting is performed on the sending version of the second-type DCI. Both the sending version of the second-type DCI and the DCI indication information are 3-digit binary bits, and a preset initial value of the DCI indication information is 0. The second-type DCI carries the sending version.

As shown in FIG. 3B, the terminal receives current first-type DCI in the sTTI3 (It should be noted that, FIG. 3A shows the structure of the downlink time-frequency resource, and the sTTI3 is a downlink sTTI number. For ease of description, the sTTI number shown in FIG. 3B is used to describe receiving on the terminal side). The second-type DCI baseline version maintained by the terminal is a sending version (0) of second-type DCI received by the terminal in the sTTI0. The terminal determines whether DCI indication information (0) in the currently received first-type DCI is the same as the second-type DCI baseline version (0). If the DCI indication information (0) is the same as the second-type DCI baseline version (0), the terminal determines that the current first-type DCI received in the sTTI3 is valid.

The terminal receives current first-type DCI in the sTTI7. Assuming that the terminal has not received second-type DCI in the sTTI7, second-type DCI that is most recently received by the terminal is second-type DCI received in the sTTI0. The second-type DCI baseline version maintained by the terminal is the sending version (0) of the second-type DCI received in the sTTI0. The terminal determines whether DCI indication information (1) in the currently received first-type DCI is the same as the second-type DCI baseline version (0). If the DCI indication information (1) is different from the second-type DCI baseline version (0), the terminal determines that the current first-type DCI received in the sTTI7 is invalid.

It should be noted that, the second-type DCI baseline version is a version updated based on the second-type DCI baseline version after the terminal has most recently received the second-type DCI. A specific implementation of updating is not limited in this embodiment of the present invention, but an updating manner needs to be corresponding to a setting rule of the sending version of the second-type DCI.

In one implementation, ascending loop counting may be performed on the sending version of the second-type DCI. After the terminal has most recently received the second-type DCI, the second-type DCI baseline version may increase by 1.

In another implementation, descending loop counting may be performed on the sending version of the second-type DCI. After the terminal has most recently received the second-type DCI, the second-type DCI baseline version may decrease by 1.

In still another implementation, alternate counting of two values may be performed on the sending version of the second-type DCI. After the terminal has most recently received the second-type DCI, the second-type DCI baseline version may be updated in the manner of alternate counting of two values.

The embodiment of the present invention provides the downlink control information communication method, and provides the specific implementation in which the base station generates the DCI indication information, and the terminal determines, based on the DCI indication information in the currently received first-type DCI, whether the currently received first-type DCI is valid in Embodiment 1. In the downlink control information communication method provided in the embodiment of the present invention, the terminal performs correct data scheduling only when the first-type DCI is valid. This avoids a problem that the terminal performs incorrect data scheduling when the terminal misses receiving the second-type DCI, increases a scheduling success rate of the terminal, and reduces power consumption of the terminal.

Based on the embodiment shown in FIG. 2, a downlink control information communication method provided in the embodiments of the present invention provides still another implementation of the downlink control information communication method, and particularly provides specific implementations of S101 and S104 in Embodiment 1.

In the embodiment of the present invention, that a base station generates DCI indication information in S101 may include:

the base station determines whether the second-type DCI has been sent to the terminal after previous first-type DCI sending and before the current first-type DCI sending; and

if the second-type DCI has not been sent, the base station sets the DCI indication information in the current first-type DCI to a first preset value, where the first preset value indicates that the base station has not sent the second-type DCI after the previous first-type DCI sending and before the current first-type DCI sending; or

if the second-type DCI has been sent, the base station sets the DCI indication information in the current first-type DCI to a second preset value, where the second preset value indicates that the base station has sent the second-type DCI after the previous first-type DCI sending and before the current first-type DCI sending.

The first preset value and the second preset value are set as needed.

The following describes the foregoing operations in detail by using specific examples.

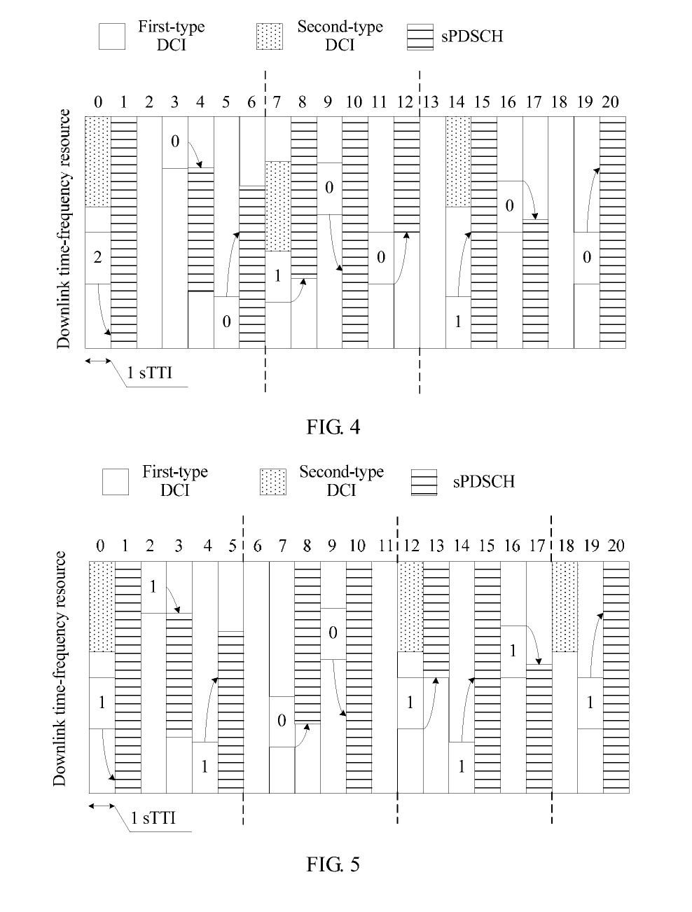

FIG. 4 is a schematic structural diagram of a downlink time-frequency resource in the downlink control information communication method according to the embodiments of the present invention. As shown in FIG. 4, an sTTI is a symbol TTI, numbers of sTTIs are 0 to 20, and the sTTI are marked as an sTTI0 to an sTTI020. Downlink data sent by the base station is transmitted on an sPDSCH. The first preset value is set to 0, the second preset value is set to 1, and a preset initial value of the DCI indication information is 2.

After the base station determines that the terminal enters the sTTI mode, the base station sends a first piece of first-type DCI and a first piece of second-type DCI in the sTTI0. DCI indication information in the first piece of first-type DCI is initialized as 2.

After sending the first-type DCI in the sTTI0, the base station sends current first-type DCI in the sTTI3. The base station needs to determine whether second-type DCI has been sent to the terminal after the first-type DCI sending in the sTTI0 and before the current first-type DCI sending in the sTTI3, and if determining that the second-type DCI has not been sent, the base station sets DCI indication information in the current first-type DCI sent in the sTTI3 to 0.

After sending first-type DCI in the sTTI5, the base station sends current first-type DCI in the sTTI7. The base station needs to determine whether second-type DCI has been sent to the terminal after the first-type DCI sending in the sTTI5 and before the current first-type DCI sending in the sTTI7, and if determining that the second-type DCI has been sent, the base station sets DCI indication information in the current first-type DCI sent in the sTTI7 to 1.

In the embodiment of the present invention, the DCI indication information is a first preset value or a second preset value. The first preset value indicates that the base station has not sent the second-type DCI after previous first-type DCI sending and before current first-type DCI sending. The second preset value indicates that the base station has sent the second-type DCI after the previous first-type DCI sending and before the current first-type DCI sending.

Correspondingly, that the terminal determines, based on the DCI indication information in the currently received first-type DCI, whether the currently received first-type DCI is valid in S104 may include:

if the DCI indication information is the first preset value, the terminal determines that the currently received first-type DCI is valid; or

if the DCI indication information is the second preset value, the terminal further determines whether the second-type DCI has been received after previous first-type DCI receiving and before the current first-type DCI receiving; and

if the second-type DCI has been received, the terminal determines that the currently received first-type DCI is valid, or if the second-type DCI has not been received, the terminal determines that the currently received first-type DCI is invalid.

The following describes the foregoing operations in detail by using specific examples.

As shown in FIG. 4, the terminal receives the current first-type DCI in the sTTI3 (It should be noted that, FIG. 4 shows the structure of the downlink time-frequency resource, and the sTTI3 is a downlink sTTI number. For ease of description, the sTTI number shown in FIG. 4 is used to describe receiving on the terminal side). If the DCI indication information in the current first-type DCI is 0, the terminal determines that the current first-type DCI received in the sTTI3 is valid.

The terminal receives the current first-type DCI in the sTTI7. If the DCI indication information in the current first-type DCI is 1, the terminal further needs to determine whether the second-type DCI has been received after the first-type DCI receiving in the sTTI5 and before the first-type DCI receiving in the sTTI7. If having received the second-type DCI in the sTTI7, the terminal determines that the current first-type DCI received in the sTTI7 is valid, or if having not received the second-type DCI in the sTTI7, the terminal determines that the current first-type DCI received in the sTTI7 is invalid.

The embodiment of the present invention provides the downlink control information communication method, and provides the specific implementation in which the base station generates the DCI indication information, and the terminal determines, based on the DCI indication information in the currently received first-type DCI, whether the currently received first-type DCI is valid. In the downlink control information communication method provided in the embodiment of the present invention, the terminal performs correct data scheduling only when the first-type DCI is valid. This avoids a problem that the terminal performs incorrect data scheduling when the terminal misses receiving the second-type DCI, increases a scheduling success rate of the terminal, and reduces power consumption of the terminal.

Based on the embodiment shown in FIG. 2, a downlink control information communication method provided in the embodiments of the present invention provides yet another implementation of the downlink control information communication method, and particularly provides specific implementations of S101 and S104 with regard to a case in which a base station sends second-type DCI based on a preset period.

In the embodiment of the present invention, the base station sends the second-type DCI based on the preset period, and that a base station generates DCI indication information in S101 may include:

the base station determines whether the second-type DCI has been sent to the terminal within a current second-type DCI sending period; and

if the second-type DCI has not been sent, the base station sets the DCI indication information in the first-type DCI that is within the current second-type DCI sending period to a third preset value, where the third preset value indicates that the base station has not sent the second-type DCI within the current second-type DCI sending period; or

if the second-type DCI has been sent, the base station sets the DCI indication information in the first-type DCI that is within the current second-type DCI sending period to a fourth preset value, where the fourth preset value indicates that the base station has sent the second-type DCI within the current second-type DCI sending period.

The preset period, the third preset value, and the fourth preset value are set as needed.

The second-type DCI is usually located on a first OFDM symbol within the second-type DCI sending period.

The following describes the foregoing operations in detail by using specific examples.

FIG. 5 is a schematic structural diagram of a downlink time-frequency resource in the downlink control information communication method according to the embodiments of the present invention. As shown in FIG. 5, an sTTI is a symbol TTI, numbers of sTTIs are 0 to 20, and the sTTIs are marked as an sTTI0 to an sTTI020. Downlink data sent by the base station is transmitted on an sPDSCH. The third preset value is set to 0, the fourth preset value is set to 1, and the preset period includes six sTTIs. Sending periods of second-type DCI are an sTTI0 to an sTTI05, an sTTI6 to an sTTI011, and an sTTI12 to an sTTI017.

If the base station determines that second-type DCI has been sent in the sTTI0, the base station sets DCI indication information in first-type DCI that is within the sending period to 1. In other words, the base station sets DCI indication information in first-type DCI sent in the sTTI0, the sTTI2, and the sTTI4 to 1.

If the base station determines that second-type DCI has not been sent in the sTTI6, the base station sets DCI indication information in first-type DCI that is within the sending period to 0. In other words, the base station sets DCI indication information in first-type DCI sent in the sTTI7 and the sTTI9 to 0.

In the embodiment of the present invention, the second-type DCI is sent by the base station based on a preset period, and the DCI indication information is a third preset value or a fourth preset value. The third preset value indicates that the base station has not sent the second-type DCI within a current second-type DCI sending period. The fourth preset value indicates that the base station has sent the second-type DCI within the current second-type DCI sending period.

Correspondingly, that the terminal determines, based on the DCI indication information in the currently received first-type DCI, whether the currently received first-type DCI is valid in S104 may include:

if the DCI indication information is the third preset value, the terminal determines that the currently received first-type DCI is valid; or

if the DCI indication information is the fourth preset value, the terminal further determines whether the second-type DCI has been received within the current second-type DCI sending period; and

if the second-type DCI has been received, the terminal determines that the currently received first-type DCI is valid, or if the second-type DCI has not been received, the terminal determines that the currently received first-type DCI is invalid.

The following describes the foregoing operations in detail by using specific examples.

As shown in FIG. 5, the terminal receives current first-type DCI in the sTTI3 (It should be noted that, FIG. 5 shows the structure of the downlink time-frequency resource, and the sTTI3 is a downlink sTTI number. For ease of description, the sTTI number shown in FIG. 5 is used to describe receiving on the terminal side). If DCI indication information in the current first-type DCI is 1, the terminal further needs to determine whether the terminal has received second-type DCI within the second-type DCI sending period. If having received the second-type DCI in the sTTI0, the terminal determines that the current first-type DCI received in the sTTI3 is valid, or if having not received the second-type DCI in the sTTI0, the terminal determines that the current first-type DCI received in the sTTI3 is invalid.

The terminal receives current first-type DCI in the sTTI7. If DCI indication information in the current first-type DCI is 0, the terminal determines that the current first-type DCI received in the sTTI3 is valid.

The embodiment of the present invention provides the downlink control information communication method, and provides the specific implementation in which the base station generates the DCI indication information, and the terminal determines, based on the DCI indication information in the currently received first-type DCI, whether the currently received first-type DCI is valid. In the downlink control information communication method provided in the embodiment of the present invention, the terminal performs correct data scheduling only when the first-type DCI is valid. This avoids a problem that the terminal performs incorrect data scheduling when the terminal misses receiving the second-type DCI, increases a scheduling success rate of the terminal, and reduces power consumption of the terminal.

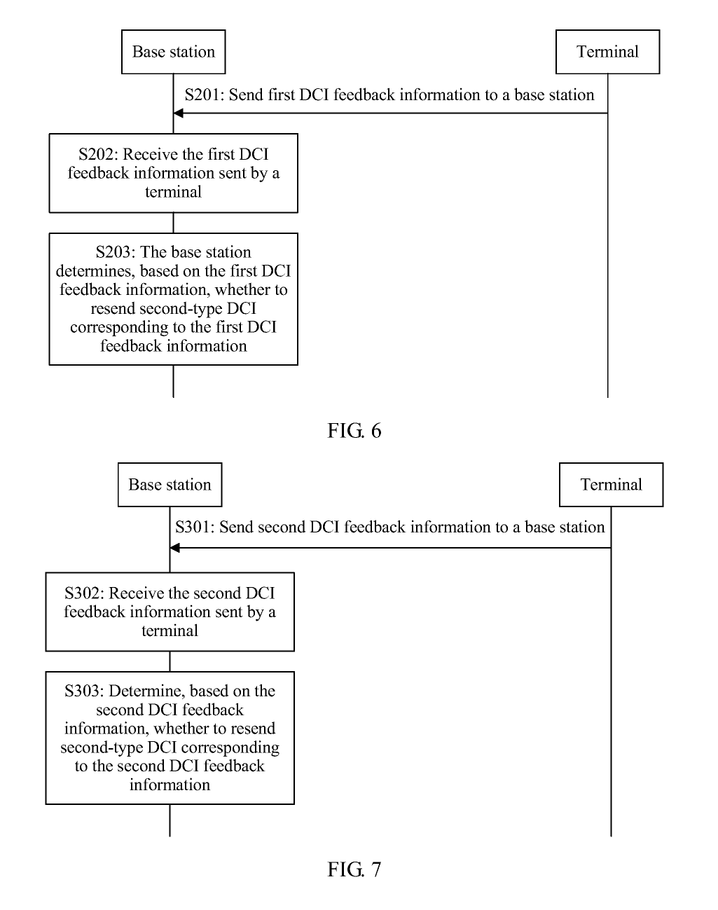

FIG. 6 is a signaling flowchart of a downlink control information communication method according to the embodiments of the present invention. Based on the method embodiments 1 to 5, the embodiment of the present invention provides still yet another implementation of the downlink control information communication method. As shown in FIG. 6, the downlink control information communication method provided in the embodiment of the present invention may further include the following operations.

S201: A terminal sends first DCI feedback information to a base station.

The first DCI feedback information is used to indicate whether currently received first-type DCI is valid.

Specifically, when the terminal determines that the first-type DCI is valid, it indicates that the first-type DCI currently received by the terminal is corresponding to second-type DCI that is most recently received by the terminal. In this case, the terminal may perform correct data scheduling.

When the terminal determines that the first-type DCI is invalid, it indicates that the first-type DCI currently received by the terminal is not corresponding to the second-type DCI that is most recently received by the terminal. In this case, the terminal cannot perform correct data scheduling, and the terminal does not perform data scheduling indicated by the first-type DCI. The terminal determines, based on DCI indication information in the currently received first-type DCI, that the currently received first-type DCI is invalid. Therefore, it indicates that the second-type DCI that is most recently received by the terminal does not match the currently received first-type DCI, namely, the terminal misses receiving the second-type DCI that is most recently sent by the base station. In this case, although the terminal does not perform data scheduling indicated by the first-type DCI, the base station side does not learn that the terminal misses receiving the second-type DCI, and still sends downlink data or waits for receiving uplink data, causing a waste of time-frequency resources on the base station side.

In the embodiment of the present invention, the terminal sends the first DCI feedback information to the base station, and the first DCI feedback information is used to indicate whether the currently received first-type DCI is valid. The terminal may notify, to the base station based on the first DCI feedback information, a result for which the terminal side determines whether the first-type DCI is valid, so that the base station performs corresponding processing based on the first DCI feedback information. This avoids a waste of time-frequency resources caused when the base station side sends downlink data.

The terminal may send the first DCI feedback information to the base station in a plurality of implementations.

In one implementation, if the first-type DCI currently received by the terminal is invalid, the terminal sends the first DCI feedback information including a negative acknowledgment indication to the base station, or if the first-type DCI currently received by the terminal is valid, the terminal sends the first DCI feedback information including an acknowledgment indication to the base station.

In another implementation, if the first-type DCI currently received by the terminal is invalid, the terminal sends the first DCI feedback information including a negative acknowledgment indication to the base station, or if the first-type DCI currently received by the terminal is valid, the terminal does not send the first DCI feedback information.

A specific implementation of the first DCI feedback information is not limited in the embodiment of the present invention. For example, the acknowledgment indication included in the first DCI feedback information may be an ACK, and the negative acknowledgment indication included in the first DCI feedback information may be a NACK.

S202: The base station receives the first DCI feedback information sent by the terminal.

The first DCI feedback information is used to indicate whether the first-type DCI currently received by the terminal is valid.

Specifically, the base station may learn of, based on the first DCI feedback information, the result for which the terminal side determines whether the first-type DCI is valid, and the base station may perform further processing based on the first DCI feedback information.

S203: The base station determines, based on the first DCI feedback information, whether to resend second-type DCI corresponding to the first DCI feedback information.

Specifically, if the first DCI feedback information includes the acknowledgment indication, the base station does not perform a resending operation. If the first DCI feedback information includes the negative acknowledgment indication, the base station resends the second-type DCI corresponding to the first DCI feedback information.

The embodiment of the present invention provides the downlink control information communication method, including: sending, by the terminal, the first DCI feedback information to the base station, where the first DCI feedback information is used to indicate whether the currently received first-type DCI is valid; receiving, by the base station, the first DCI feedback information sent by the terminal; and determining, by the base station based on the first DCI feedback information, whether to resend the second-type DCI corresponding to the first DCI feedback information. In the downlink control information communication method provided in the embodiment of the present invention, the terminal notifies, to the base station based on the first DCI feedback information, the result of determining whether the first-type DCI is valid, and the base station performs corresponding processing based on the first DCI feedback information. This avoids a waste of time-frequency resources on the base station side caused when the terminal misses receiving the second-type DCI.

FIG. 7 is a signaling flowchart of a downlink control information communication method according to the embodiments of the present invention. Based on the method embodiments 1 to 5, the embodiment of the present invention provides a further implementation of the downlink control information communication method. As shown in FIG. 7, the downlink control information communication method provided in the embodiment of the present invention may further include the following operations.

S301: A terminal sends second DCI feedback information to a base station.

The second DCI feedback information is used to indicate whether the terminal has received second-type DCI.

Specifically, when the terminal has received the second-type DCI, it indicates that first-type DCI currently received by the terminal is corresponding to second-type DCI that is most recently received by the terminal. In this case, the terminal may perform correct data scheduling.

When the terminal has not received the second-type DCI, it indicates that the first-type DCI currently received by the terminal is not corresponding to the second-type DCI that is most recently received by the terminal. In this case, the terminal cannot perform correct data scheduling. However, the base station side does not learn that the terminal misses receiving the second-type DCI, and still sends downlink data or waits for receiving uplink data, causing a waste of time-frequency resources on the base station side.

In the embodiment of the present invention, the terminal sends the second DCI feedback information to the base station, and the second DCI feedback information is used to indicate whether the terminal has received the second-type DCI. The terminal may notify, to the base station based on the second DCI feedback information, a result of determining whether the terminal has received the second-type DCI, so that the base station performs corresponding processing based on the second DCI feedback information. This avoids a waste of time-frequency resources caused when the base station side sends downlink data.

The terminal may send the second DCI feedback information to the base station in a plurality of implementations.

In one implementation, if having not received the second-type DCI, the terminal sends the second DCI feedback information including a negative acknowledgment indication to the base station, or if having received the second-type DCI, the terminal sends the second DCI feedback information including an acknowledgment indication to the base station.

In another implementation, if having not received the second-type DCI, the terminal sends the second DCI feedback information including a negative acknowledgment indication to the base station, or if having received the second-type DCI, the terminal does not send the second DCI feedback information.

A specific implementation of the second DCI feedback information is not limited in the embodiment of the present invention. For example, the acknowledgment indication included in the second DCI feedback information may be an ACK, and the negative acknowledgment indication included in the second DCI feedback information may be a NACK.

S302: The base station receives the second DCI feedback information sent by the terminal.

The second DCI feedback information is used to indicate whether the terminal has received the second-type DCI.

Specifically, the base station may learn of, based on the second DCI feedback information, the result of determining whether the terminal side has received the second-type DCI, and the base station may perform further processing based on the second DCI feedback information.

S303: Determine, based on the second DCI feedback information, whether to resend second-type DCI corresponding to the second DCI feedback information.

Specifically, if the second DCI feedback information includes the acknowledgment indication, the base station does not perform a resending operation. If the second DCI feedback information includes the negative acknowledgment indication, the base station resends the second-type DCI corresponding to the second DCI feedback information.

The embodiment of the present invention provides the downlink control information communication method, including: sending, by the terminal, the second DCI feedback information to the base station, where the second DCI feedback information is used to indicate whether the terminal has received the second-type DCI; receiving, by the base station, the second DCI feedback information sent by the terminal, and determining, by the base station based on the second DCI feedback information, whether to resend the second-type DCI corresponding to the second DCI feedback information. In the downlink control information communication method provided in the embodiment of the present invention, the terminal notifies, to the base station based on the second DCI feedback information, the result of determining whether the terminal has received the second-type DCI, and the base station performs corresponding processing based on the second DCI feedback information. This avoids a waste of time-frequency resources on the base station side caused when the terminal misses receiving the second-type DCI.

Based on the method embodiments 1 to 5, Embodiment 7 of a downlink control information communication method according to the embodiments of the present invention provides a still further implementation of the downlink control information communication method. The downlink control information communication method provided in the embodiment of the present invention may further include:

receiving, by a base station, downlink scheduling feedback information sent by a terminal; and

sending second-type DCI if the downlink scheduling feedback information indicates that the terminal has not received downlink scheduling data sent by the base station; or

sending second-type DCI if uplink scheduling data sent by the terminal has not been received on a preset time-frequency resource.

In the downlink control information communication method provided in the embodiment of the present invention, the base station may learn of, based on the downlink scheduling feedback information fed back by the terminal or the uplink data sent by the terminal, whether the terminal has received the second-type DCI, and the base station may resend the second DCI based on the downlink scheduling feedback information fed back by the terminal or the uplink data sent by the terminal. This can avoid a waste of time-frequency resources on the base station side caused when the terminal misses receiving the second-type DCI.

FIG. 8 is a schematic structural diagram of a terminal according to the embodiments of the present invention. As shown in FIG. 8, a terminal 100 provided in the embodiment of the present invention may include a processor 11, and a transceiver 12 coupled to the processor 11.

The transceiver 12 is configured to receive first-type downlink control information (DCI) sent by a base station. The first-type DCI carries DCI indication information, and the DCI indication information is used to indicate a sending status of second-type DCI.

The processor 11 is configured to determine, based on the DCI indication information in the currently received first-type DCI, whether the currently received first-type DCI is valid.

When determining that the currently received first-type DCI is valid, the processor 11 performs data scheduling based on most recently received second-type DCI and the currently received first-type DCI.

Optionally, the processor 11 is further configured to:

when determining that the currently received first-type DCI is invalid, skip performing data scheduling indicated by the currently received first-type DCI.

Optionally, the DCI indication information is a sending version of the second-type DCI.

The processor 11 is configured to:

determine, based on the DCI indication information in the currently received first-type DCI and a second-type DCI baseline version maintained by the processor 11, whether the currently received first-type DCI is valid.

Optionally, the second-type DCI baseline version is DCI indication information carried in first-type DCI previously received by the transceiver 12.

The processor 11 is configured to:

determine whether the DCI indication information in the currently received first-type DCI is the same as the second-type DCI baseline version; and

if the DCI indication information in the currently received first-type DCI is the same as the second-type DCI baseline version, determine that the currently received first-type DCI is valid; or

if the DCI indication information in the currently received first-type DCI is different from the second-type DCI baseline version, further determine whether the second-type DCI has been received after the previous first-type DCI receiving and before the current first-type DCI receiving; and

if the second-type DCI has been received, determine that the currently received first-type DCI is valid, or if the second-type DCI has not been received, determine that the currently received first-type DCI is invalid.

Optionally, the second-type DCI baseline version is determined by the processor 11 based on the most recently received second-type DCI; and

that the second-type DCI baseline version is determined by the processor 11 based on the most recently received second-type DCI includes:

the second-type DCI baseline version is a sending version carried in the second-type DCI that is most recently received by the transceiver 12; or

the second-type DCI baseline version is a version updated based on the second-type DCI baseline version after the processor 11 has most recently received the second-type DCI.

Optionally, the processor 11 is configured to:

determine whether the DCI indication information in the currently received first-type DCI is the same as the second-type DCI baseline version; and

if the DCI indication information in the currently received first-type DCI is the same as the second-type DCI baseline version, determine that the currently received first-type DCI is valid; or

if the DCI indication information in the currently received first-type DCI is different from the second-type DCI baseline version, determine that the currently received first-type DCI is invalid.

Optionally, the DCI indication information is a first preset value or a second preset value.

The first preset value indicates that the base station has not sent the second-type DCI after previous first-type DCI sending and before current first-type DCI sending.

The second preset value indicates that the base station has sent the second-type DCI after the previous first-type DCI sending and before the current first-type DCI sending.

Optionally, the processor 11 is configured to:

if the DCI indication information is the first preset value, determine that the currently received first-type DCI is valid; or

if the DCI indication information is the second preset value, further determine whether the second-type DCI has been received after previous first-type DCI receiving and before the current first-type DCI receiving; and

if the second-type DCI has been received, determine that the currently received first-type DCI is valid, or if the second-type DCI has not been received, determine that the currently received first-type DCI is invalid.

Optionally, the second-type DCI is sent by the base station based on a preset period, and the DCI indication information is a third preset value or a fourth preset value.

The third preset value indicates that the base station has not sent the second-type DCI within a current second-type DCI sending period.

The fourth preset value indicates that the base station has sent the second-type DCI within the current second-type DCI sending period.

Optionally, the processor 11 is configured to:

if the DCI indication information is the third preset value, determine that the currently received first-type DCI is valid; or

if the DCI indication information is the fourth preset value, further determine whether the second-type DCI has been received within the current second-type DCI sending period; and

if the second-type DCI has been received, determine that the currently received first-type DCI is valid, or if the second-type DCI has not been received, determine that the currently received first-type DCI is invalid.

Optionally, the transceiver 12 is further configured to:

send first DCI feedback information to the base station, where the first DCI feedback information is used to indicate whether the currently received first-type DCI is valid.

Optionally, the transceiver 12 is configured to:

if the currently received first-type DCI is invalid, send the first DCI feedback information including a negative acknowledgment indication to the base station; or

if the currently received first-type DCI is valid, skip sending the first DCI feedback information.

Optionally, the transceiver 12 is further configured to:

send second DCI feedback information to the base station, where the second DCI feedback information is used to indicate whether the transceiver 12 has received the second-type DCI.

Optionally, the transceiver 12 is configured to:

if the transceiver 12 has not received the second-type DCI, send the second DCI feedback information including a negative acknowledgment indication to the base station; or

if the transceiver 12 has received the second-type DCI, skip sending the second DCI feedback information.

The terminal provided in the embodiment is configured to perform operations performed by the terminal in the method embodiments shown in FIG. 2 to FIG. 7. An implementation principle and a technical effect of the terminal are similar to those of the terminal in the method embodiments shown in FIG. 2 to FIG. 7, and details are not repeatedly described herein.

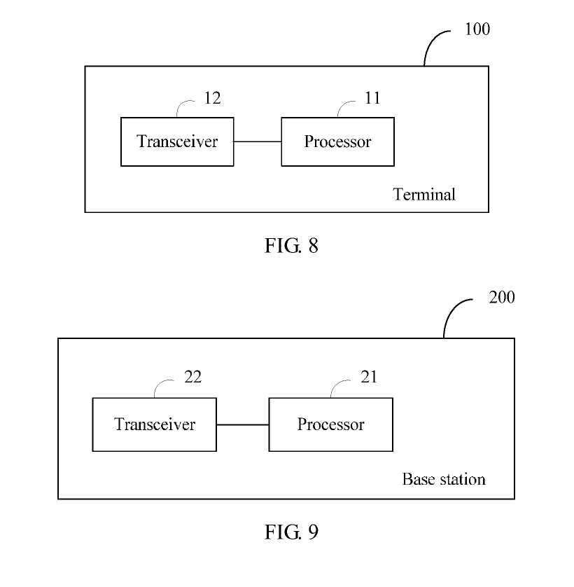

FIG. 9 is a schematic structural diagram of a base station according to the embodiments of the present invention. As shown in FIG. 9, a base station 200 provided in the embodiment of the present invention may include a processor 21, and a transceiver 22 coupled to the processor 21.

The processor 21 is configured to generate downlink control information (DCI) indication information, where the DCI indication information is used to indicate a sending status of second-type DCI.

The transceiver 22 is configured to send first-type DCI to a terminal, where the first-type DCI carries the DCI indication information.

Optionally, the DCI indication information is a sending version of the second-type DCI.

The processor 21 is configured to:

determine whether the second-type DCI has been sent to the terminal after previous first-type DCI sending and before the current first-type DCI sending; and

if the second-type DCI has been sent, use the sending version of the second-type DCI as the DCI indication information in the current first-type DCI.

Optionally, the processor 21 is configured to:

determine whether the second-type DCI has been sent to the terminal after previous first-type DCI sending and before the current first-type DCI sending; and

if the second-type DCI has not been sent, set the DCI indication information in the current first-type DCI to a first preset value; or

if the second-type DCI has been sent, set the DCI indication information in the current first-type DCI to a second preset value.

Optionally, the transceiver 22 sends the second-type DCI based on a preset period. The processor 21 is configured to:

determine whether the second-type DCI has been sent to the terminal within a current second-type DCI sending period; and

if the second-type DCI has not been sent, set the DCI indication information in the first-type DCI that is within the current second-type DCI sending period to a third preset value; or

if the second-type DCI has been sent, set the DCI indication information in the first-type DCI that is within the current second-type DCI sending period to a fourth preset value.

Optionally, the transceiver 22 is further configured to:

receive first DCI feedback information sent by the terminal, where the first DCI feedback information is used to indicate whether the first-type DCI currently received by the terminal is valid; and

determine, based on the first DCI feedback information, whether to resend second-type DCI corresponding to the first DCI feedback information.

Optionally, the transceiver 22 is further configured to:

receive second DCI feedback information sent by the terminal, where the second DCI feedback information is used to indicate whether the terminal has received the second-type DCI; and

determine, based on the second DCI feedback information, whether to resend second-type DCI corresponding to the second DCI feedback information.

Optionally, the transceiver 22 is further configured to:

receive downlink scheduling feedback information sent by the terminal; and

send the second-type DCI if the downlink scheduling feedback information indicates that the terminal has not received downlink scheduling data sent by the base station; or

send the second-type DCI if uplink scheduling data sent by the terminal has not been received on a preset time-frequency resource.

The base station provided in the embodiment is configured to perform operations performed by the base station in the method embodiments shown in FIG. 2 to FIG. 7. An implementation principle and a technical effect of the base station are similar to those of the base station in the method embodiments shown in FIG. 2 to FIG. 7, and details are not repeatedly described herein.

Finally, it should be noted that, the foregoing embodiments are merely intended to describe the technical solutions of the present application, but not to limit the present application. Although the present application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present invention.

What is claimed is:

1. A downlink control information communication method, comprising:
receiving first-type downlink control information (DCI) sent by a base station, wherein the first-type DCI carries DCI indication information, and the DCI indication information is used to indicate a sending status of second-type DCI;
determining, based on the DCI indication information in the currently received first-type DCI, whether the currently received first-type DCI is valid; and
when it is determined that the currently received first-type DCI is valid, performing data scheduling based on most recently received second-type DCI and the currently received first-type DCI.

2. The method according to claim 1, further comprising:
when it is determined that the currently received first-type DCI is invalid, skipping performing data scheduling indicated by the currently received first-type DCI.

3. The method according to claim 1, wherein the DCI indication information is a sending version of the second-type DCI; and
the determining, based on the DCI indication information in the currently received first-type DCI, whether the currently received first-type DCI is valid comprises:
determining, based on the DCI indication information in the currently received first-type DCI and a second-type DCI baseline version maintained by a terminal, whether the currently received first-type DCI is valid.

4. The method according to claim 3, wherein the second-type DCI baseline version is DCI indication information carried in the first-type DCI previously received by the terminal; and
the determining, based on the DCI indication information in the currently received first-type DCI and the second-type DCI baseline version maintained by the terminal, whether the currently received first-type DCI is valid comprises:
determining whether the DCI indication information in the currently received first-type DCI is the same as the second-type DCI baseline version; and
when the DCI indication information in the currently received first-type DCI is the same as the second-type DCI baseline version, determining that the currently received first-type DCI is valid; or
when the DCI indication information in the currently received first-type DCI is different from the second-type DCI baseline version, further determining whether the second-type DCI has been received after the previous first-type DCI receiving and before the current first-type DCI receiving; and
when the second-type DCI has been received, determining that the currently received first-type DCI is valid, or when the second-type DCI has not been received, determining that the currently received first-type DCI is invalid.

5. The method according to claim 3, wherein the second-type DCI baseline version is determined by the terminal based on the most recently received second-type DCI; and
wherein the second-type DCI baseline version is determined by the terminal based on the most recently received second-type DCI comprises:
the second-type DCI baseline version that is a sending version carried in the second-type DCI that is most recently received by the terminal; or
the second-type DCI baseline version that is a version updated based on the second-type DCI baseline version after the terminal has most recently received the second-type DCI.

6. The method according to claim 5, wherein the determining, based on the DCI indication information in the currently received first-type DCI and the second-type DCI baseline version maintained by the terminal, whether the currently received first-type DCI is valid comprises:
determining whether the DCI indication information in the currently received first-type DCI is the same as the second-type DCI baseline version; and
when the DCI indication information in the currently received first-type DCI is the same as the second-type DCI baseline version, determining that the currently received first-type DCI is valid; or
when the DCI indication information in the currently received first-type DCI is different from the second-type DCI baseline version, determining that the currently received first-type DCI is invalid.

7. The method according to claim 1, wherein the DCI indication information is a first preset value or a second preset value;
wherein the first preset value indicates that the base station has not sent the second-type DCI after a previous first-type DCI sending and before a current first-type DCI sending; and
the second preset value indicates that the base station has sent the second-type DCI after the previous first-type DCI sending and before the current first-type DCI sending.

8. The method according to claim 1, wherein the second-type DCI is sent by the base station based on a preset period, and the DCI indication information is a third preset value or a fourth preset value;
wherein the third preset value indicates that the base station has not sent the second-type DCI within a current second-type DCI sending period; and
the fourth preset value indicates that the base station has sent the second-type DCI within the current second-type DCI sending period.

9. A terminal, comprising a processor, and a transceiver coupled to the processor; wherein
the transceiver is configured to receive first-type downlink control information (DCI) sent by a base station, wherein the first-type DCI carries DCI indication information, and the DCI indication information is used to indicate a sending status of second-type DCI;
the processor is configured to determine, based on the DCI indication information in the currently received first-type DCI, whether the currently received first-type DCI is valid; and
when determining that the currently received first-type DCI is valid, the processor performs data scheduling based on most recently received second-type DCI and the currently received first-type DCI.

10. The terminal according to claim 9, wherein the processor is further configured to:
when determining that the currently received first-type DCI is invalid, skip performing data scheduling indicated by the currently received first-type DCI.

11. The terminal according to claim 9, wherein the DCI indication information is a sending version of the second-type DCI; and
wherein the processor is configured to:
determine, based on the DCI indication information in the currently received first-type DCI and a second-type DCI baseline version maintained by the processor, whether the currently received first-type DCI is valid.

12. The terminal according to claim 11, wherein the second-type DCI baseline version is DCI indication information carried in the first-type DCI previously received by the transceiver; and
the processor is configured to:
determine whether the DCI indication information in the currently received first-type DCI is the same as the second-type DCI baseline version; and
when the DCI indication information in the currently received first-type DCI is the same as the second-type DCI baseline version, determine that the currently received first-type DCI is valid; or
when the DCI indication information in the currently received first-type DCI is different from the second-type DCI baseline version, further determine whether the second-type DCI has been received after the previous first-type DCI receiving and before the current first-type DCI receiving; and
when the second-type DCI has been received, determine that the currently received first-type DCI is valid, or when the second-type DCI has not been received, determine that the currently received first-type DCI is invalid.

13. The terminal according to claim 11, wherein the second-type DCI baseline version is determined by the processor based on the most recently received second-type DCI; and
wherein the second-type DCI baseline version is determined by the processor based on the most recently received second-type DCI comprises:
the second-type DCI baseline version that is a sending version carried in the second-type DCI that is most recently received by the transceiver; or
the second-type DCI baseline version that is a version updated based on the second-type DCI baseline version after the processor has most recently received the second-type DCI.

14. The terminal according to claim 13, wherein the processor is configured to:
determine whether the DCI indication information in the currently received first-type DCI is the same as the second-type DCI baseline version; and
when the DCI indication information in the currently received first-type DCI is the same as the second-type DCI baseline version, determine that the currently received first-type DCI is valid; or
when the DCI indication information in the currently received first-type DCI is different from the second-type DCI baseline version, determine that the currently received first-type DCI is invalid.

15. The terminal according to claim 9, wherein the DCI indication information is a first preset value or a second preset value;
wherein the first preset value indicates that the base station has not sent the second-type DCI after a previous first-type DCI sending and before a current first-type DCI sending; and
the second preset value indicates that the base station has sent the second-type DCI after the previous first-type DCI sending and before the current first-type DCI sending.

16. The terminal according to claim 9, wherein the second-type DCI is sent by the base station based on a preset period, and the DCI indication information is a third preset value or a fourth preset value;
wherein the third preset value indicates that the base station has not sent the second-type DCI within a current second-type DCI sending period; and
the fourth preset value indicates that the base station has sent second-type DCI within the current second-type DCI sending period.

17. A base station, comprising a processor, and a transceiver coupled to the processor; wherein
the processor is configured to generate downlink control information (DCI) indication information, wherein the DCI indication information is used to indicate a sending status of second-type DCI; and
the transceiver is configured to send first-type DCI to a terminal, wherein the first-type DCI carries the DCI indication information.

18. The base station according to claim 17, wherein the DCI indication information is a sending version of second-type DCI; and
the processor is configured to:
determine whether the second-type DCI has been sent to the terminal after a previous first-type DCI sending and before the current first-type DCI sending; and
when second-type DCI has been sent, use the sending version of the second-type DCI as the DCI indication information in the current first-type DCI.

19. The base station according to claim 17, wherein the processor is configured to:
determine whether the second-type DCI has been sent to the terminal after the previous first-type DCI sending and before the current first-type DCI sending; and
when second-type DCI has not been sent, set the DCI indication information in the current first-type DCI to a first preset value; or
when second-type DCI has been sent, set the DCI indication information in the current first-type DCI to a second preset value.

20. The base station according to claim 17, wherein the transceiver sends the second-type DCI based on a preset period, and the processor is configured to:
determine whether the second-type DCI has been sent to the terminal within a current second-type DCI sending period; and
when second-type DCI has not been sent, set the DCI indication information in the first-type DCI that is within the current second-type DCI sending period to a third preset value; or
when second-type DCI has been sent, set the DCI indication information in the first-type DCI that is within the current second-type DCI sending period to a fourth preset value.
